(19) United States
(12) Patent Application Publication
(10) Pub. No.: US 2023/0121901 A1
(43) Pub. Date: Apr. 20, 2023

(54) COMPUTERIZED METHOD FOR AUDITABLE TRANSFORMATION BETWEEN ACCOUNTING AND ACTUARIAL DATA

(71) Applicant: Zurich Insurance Company Ltd., Zurich (CH)

(72) Inventors: Dusan Hutka, Bratislava (SK); Andrea Smith, Zurich (CH)

(73) Assignee: Zurich Insurance Company Ltd., Zurich (CH)

(21) Appl. No.: 17/965,615

(22) Filed: Oct. 13, 2022

Related U.S. Application Data
(60) Provisional application No. 63/310,374, filed on Feb. 15, 2022.
(60) Provisional application No. 63/255,713, filed on Oct. 14, 2021.

(51) Int. Cl. G06Q 40/00

(52) U.S. Cl. CPC G06Q 40/12

(57) ABSTRACT

A computer system receives accounting inputs and performs calculations and generates reports that transform the accounting inputs into actuarial outputs, such as a contractual service margin (CSM) according to IFRS 17. The computer system generates an audit trail enabling the calculations and report generation to be repeated. The audit trail may include associating version data with entities used to generate the actuarial outputs, where the entities include a formula, workflow, procedure, algorithm, and a software module. Entities may also include master data used to generate the actuarial outputs. Projected values for the actuarial outputs and sensitivity analysis may be performed by processing adjusted versions of the accounting inputs.

### CROSS-REFERENCE TO RELATED APPLICATIONS

The present application claims the benefit of U.S. Provisional Patent Application No. 63/255,713 filed Oct. 14, 2021, entitled “IFRS 17 LIFE ACTUARIAL CALCULATION ENGINE”, and U.S. Provisional Patent Application No. 63/310,374 filed Feb. 15, 2022, entitled “COMPUTERIZED METHOD FOR AUDITABLE TRANSFORMATION BETWEEN ACCOUNTING AND ACTUATORIAL DATA”, which are hereby incorporated herein by reference in their entirety.

### BACKGROUND

The International Accounting Standards Board (IASB) issued the International Financial Reporting Standard 17 (IFRS 17) in May 2017. IFRS 17 establishes standards for insurance contracts. In particular, IFRS 17 defines a “contractual service margin” that is a function of the present value of future insurance cashflows and risk. The standard is extremely complex and has been challenging for insurers to implement.

It would be an advancement in the art to provide an improved approach for implementing IFRS 17.

### BRIEF DESCRIPTION OF THE FIGURES

In order that the advantages of the present disclosure will be readily understood, a more particular description of the invention briefly described above will be rendered by reference to exemplary embodiment(s) illustrated in the appended drawings. Understanding that these drawings depict only typical exemplary embodiments of the subject disclosure and are not therefore to be considered limiting of its scope. The exemplary embodiments of the subject disclosure will be described and explained with additional specificity and detail through use of the accompanying drawings, in which:

FIG. 1 is a schematic block diagram of an actuarial engine in an actuarial system in accordance with an exemplary embodiment of the present disclosure;

FIG. 2 is a schematic block diagram of the actuarial system of FIG. 1 in accordance with an exemplary embodiment of the present disclosure;

FIG. 3 is a schematic block diagram of a method for transforming accounting data into actuarial data in an auditable manner in accordance with an exemplary embodiment of the present disclosure;

FIG. 4 is a schematic block diagram of input, output, and master data for the method of FIG. 3 in accordance with an exemplary embodiment of the present disclosure;

FIG. 5 is a schematic block diagram illustrating details of the processing according to the method of FIG. 3 in accordance with an exemplary embodiment of the present disclosure;

FIG. 6 is a schematic block diagram illustrating the auditable transformation of accounting data into actuarial data in accordance with an exemplary embodiment of the present disclosure; and

FIG. 7 is a schematic block diagram of a computer system suitable for implementing methods in accordance with exemplary embodiments of the present disclosure.

### DETAILED DESCRIPTION

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

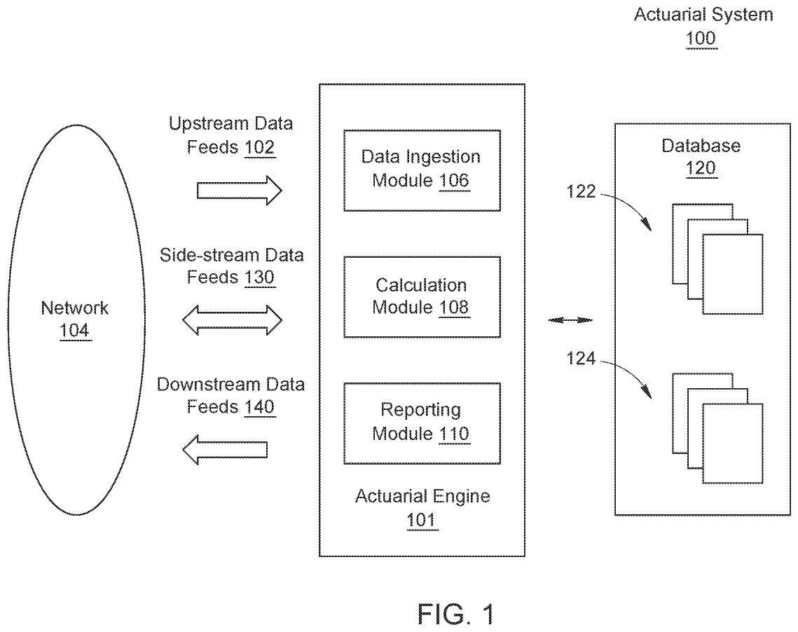

FIG. 1 illustrates an actuarial system 100 to provide data consolidation, calculation, and reporting services using an actuarial engine (ACE) 100 according to examples of the present disclosure. While FIG. 1 illustrates various components contained in the actuarial system 100, FIG. 1 illustrates one example of an actuarial system of the present disclosure, and additional components can be added and existing components can be removed.

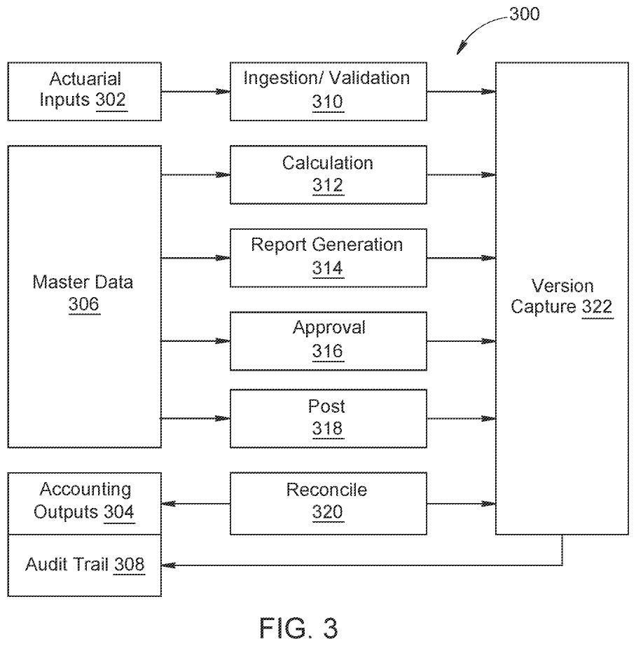

As illustrated in FIG. 1, the ACE 101 is configured to provide a centralized service for receiving data, consolidating the data into a single format, storing the consolidated data, performing various calculations using the data, and providing reports on the same. For example, the ACE 101 can be configured to perform fiscal period reporting and posting under IFSR 17. The ACE 101 is configured to receive data via one or more upstream feeds 102. In some embodiments, the data can include data that describes a business entity and the operations of the business entity. For example, the data can include projected cash flows, actual cash flows, business entity reference data, and master data, as described below in further detail in FIGS. 3-5. The ACE 101 includes one or more algorithms, models, etc. that operate on the data to determine the operational status of the business entity. The ACE 101 is configured to generate one or more visualization and reports that embody the calculations performed by the ACE 101. The ACE 101 can be configured to provide the visualization and reports via one or more side-stream data feeds 130 and one or more downstream data feeds 140.

In embodiments, the upstream data feeds 102, side-stream data feeds 130, and downstream data feeds 140 can communicate data via one or more networks 104. The network 104 can include public networks, e.g., the Internet, and private networks. The ACE 101 can be configured to provide one or more application programming interfaces (APIs) to implement the upstream data feeds 102, side-stream data feeds 130, and downstream data feeds 140. The upstream data feed 102 can represent a primary, inbound data feed for the ACE 101. The side-stream data feed 130 can be a data feed for providing secondary data to the ACE 101, and for retrieving and/or viewing data in the ACE 101. The downstream data feed 140 can be the primary outbound data feed for the ACE 101.

In embodiments, the ACE 101 can include a data ingestion module 106 for receiving data via the upstream data feeds 102 and/or the side stream data feeds 130. The data ingestion module 106 can define several processes and areas for receiving, importing, transforming, and validating data. The data ingestion module 106 can define a pre-staging area for receiving data from the upstream data feeds 102 and/or the side stream data feeds 130. The data can be imported from the upstream data feeds 102 and/or the side stream data feeds 130 to a pre-staging area. The data ingestion module 106 can import the data in response to action taken by a user and/or an automation rule for importing data. The data ingestion module 106 can store an original (“as-is”) copy 122 of the data in a secure database 120. In embodiments, the original copy 122 can be utilized to audit the calculations performed and reports generated by the ACE 101.

The data ingestion module 106 also implements data ingestion pipelines from the pre-staging area to a staging area for delivery to a calculation module 108 and the secure database 120. The ingestion pipelines can perform the import of data feed payloads held in the pre-staging area, control the data based on pre-defined validation rules, and map data payload to the staging tables and the secure database 120 as a curated copy 124 of the data. In some embodiments, the ingestion pipelines can be segregated such that each pipeline handles a specific data payload. The data ingestion module 106 can utilize one or more data validation rules to manage any dependencies between different data payloads. The data ingestion module 106 can generate error logs based on errors in the data payloads. In some embodiments, the data ingestion module 106 can suspend the data pipelines in the event of an error to maintain data sequencing rules across data payloads.

The data ingestion module 106 can also create and store an entry in a data catalog for each payload imported. The data catalog can be a summary of the type of data that was imported for use by the calculation module 108. For example, if the payload included projected cashflows, an entry can be stored in the catalog identifying the business unit and a count of each cash flow type. The catalog can also be utilized for auditing at a later stage. In embodiments, the data ingestion module 106 can also transform and/or format the payloads in a format utilized by the ACE 101. Once transformed or formatted, the curated copy 124 of the data can be stored in the secure database 120. The curated copy 124 can also include a link to the original copy 122 for auditing purposes.

In embodiments, once data is received, the calculation module 108 can perform any required calculations on the curated copy 124. A reporting module 110 can generate reports and visualization of the curated copy 124 and the calculations performed by the calculation module 108. In some embodiments, once data is the curated copy 124 is available, the calculation module 108 and the reporting module 110 can automatically begin executing the calculation and reporting processes as described below in FIGS. 3-6. The calculations performed and the reports generated can be determined based on rules stored in the ACE 101.

In embodiments, the ACE 101 can be implemented as a software program or software application containing modules or components that are configured to perform the processes as described herein. Likewise, the ACE 101 can be implemented as a portion of other software programs or applications. In either case, the ACE 101 can be configured to include the necessary logic, commands, instructions, and protocols to perform the processes and methods described herein. The ACE 101 can be written in any type of conventional programming languages such as C, C++, JAVA, Perl, Python, and the like.

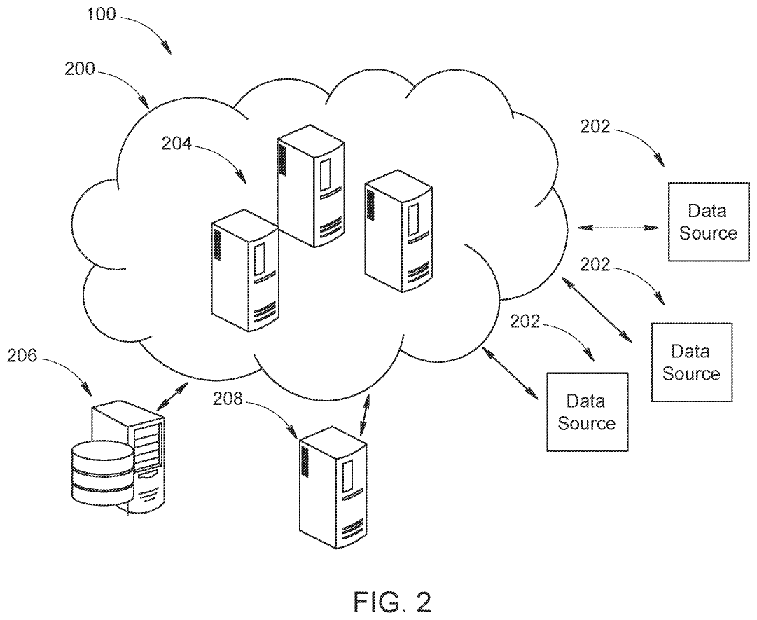

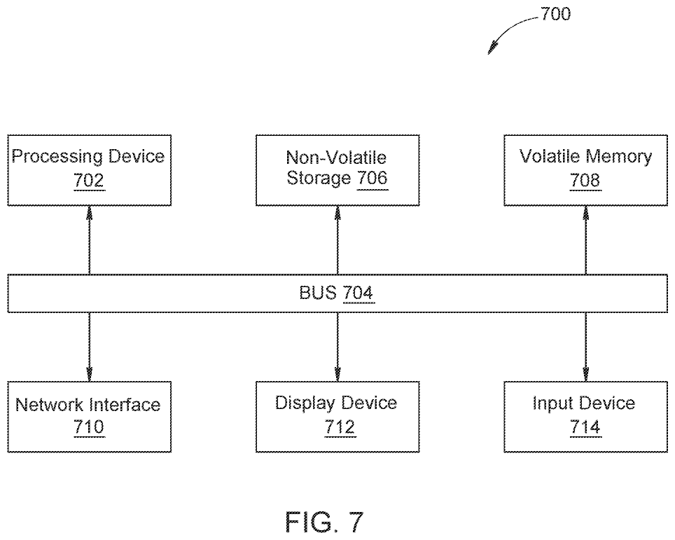

The actuarial system 100 can include one or more computing systems or devices that are configured to implement the ACE 101, as described below in FIG. 2 and FIG. 7. The computing systems or devices can be one more of any type of computing system capable of executing the ACE 101, such as servers, laptops, desktops, cloud computing services, and the like. The computing system and devices can include several hardware resources, which are used to execute the ACE 101 such as processors, memory, network hardware, bandwidth, storage devices, etc., and a number of software resources, such as operating systems, application programs, software appliances, etc. The ACE 101 can be stored in computer-readable storage devices or media (CD, DVD, hard drive, portable storage memory, etc.) whether local to the computing system and devices or remotely located. FIG. 2 illustrates the actuarial system 100 in accordance with an exemplary embodiment of the present disclosure. The actuarial system 100 includes internal and external data resources for implementing and executing the ACE 101 as described above and below in further detail.

The actuarial system 100 includes a data management system 200 that implements the ACE 101. The data management system 200 communicates with one or more data sources 202. In some embodiments, the data sources 202 can include one or more computer systems that communicate data, via the network 104 (not shown), users of the ACE 101, and combinations thereof. In some embodiments, the data management system 200 can be implemented using physical computer systems, cloud computing services, and combinations thereof. In any embodiment, the data management system 200 can include one or more servers 204 such as application servers, database servers, and data servers. The actuarial system 100 can include external resources such as an external application server 208 and/or an external database server 206. The various elements of the actuarial system 100 can communicate via various communication links through the network 104. An external resource can generally be considered a data resource owned and/or operated by an entity other than an entity that utilizes the data management system 202.

As used herein, a “cloud” or “cloud computing service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

The data management system 200 can be network-based and accessible via the network 104. In some embodiments, the data sources 202 can access the data management system 200 via an online portal set up and/or managed by one or more of the servers 204, e.g., the application server. In some embodiments, the data sources 202 can include one or more applications that access the services of the data management system 202 via one or more APIs and that access the processes of the ACE 101. Elements of the actuarial system 100, such as the database server 206 and/or the application server 208, can be physically housed at a location remote from an entity that owns and/or operates the actuarial system 100. For example, various elements of the actuarial system 100 can be physically housed at a public service provider such as a web services provider or cloud services provider. Elements of the actuarial system 100 can be physically housed at a private location, such as at a location occupied by the entity that owns and/or operates the actuarial system 100.

The communication links by which the actuarial system 100, e.g., the data management system 200, and the data sources 202 communicate can be direct or indirect. A direct link can include a link between two devices where information is communicated from one device to the other without passing through an intermediary. For example, the direct link can include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link can include a cable on a bus network. “Direct,” when used regarding the communication links, can refer to any of the aforementioned direct communication links.

An indirect link can include a link between two or more devices where data can pass through an intermediary, such as a router, before being received by an intended recipient of the data. For example, the indirect link can include a wireless fidelity (WiFi) connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links, can refer to any of the aforementioned indirect communication links.

In embodiments, as described below in FIG. 7, various components of the actuarial system 100 can include data storage and/or processing capabilities. Such capabilities can be rendered by various electronics for processing and/or storing electronic signals. For example, the actuarial system 100 can include one or more processing devices and one or more memory devices. The processing device can be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” can be used generically to refer to any or all of the aforementioned specific devices, elements, and/or features of the processing device. The memory device can be and/or include a computer processing unit register, a cache memory, a magnetic disk, an optical disk, a solid-state drive, and so forth. The memory device can be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

In embodiments, various components of the actuarial system 100 and data sources 202 can include data communication capabilities. Such capabilities can be rendered by various electronics for transmitting and/or receiving electronic and/or electromagnetic signals. For example, various components of the actuarial system 100 and data sources 202 can include one or more communication devices. The communication device can include, for example, a networking chip, one or more antennas, and/or one or more communication ports. The communication device can generate radio frequency (RF) signals and transmit the RF signals via one or more of the antennas. The communication device can receive and/or translate the RF signals. The communication device can transceive the RF signals. The RF signals can be broadcast and/or received by the antennas. The communication device can generate electronic signals and transmit the RF signals via one or more of the communication ports. The communication device can receive the RF signals from one or more of the communication ports. The electronic signals can be transmitted to and/or from a communication hardline by the communication ports. The communication device can generate optical signals and transmit the optical signals to one or more of the communication ports. The communication device can receive the optical signals and/or can generate one or more digital signals based on the optical signals. The optical signals can be transmitted to and/or received from a communication hardline by the communication port, and/or the optical signals can be transmitted and/or received across open space by the networking device.

The communication device can include hardware and/or software for generating and communicating signals over a direct and/or indirect network communication link. For example, the communication component can include a USB port and a USB wire, and/or an RF antenna with Bluetooth™ programming installed on a processor, such as the processing component, coupled to the antenna. In another example, the communication component can include an RF antenna and programming installed on a processor, such as the processing device, for communicating over a Wifi and/or cellular network. As used herein, “communication device” “communication component,” and/or “communication unit” can be used generically herein to refer to any or all of the aforementioned elements and/or features of the communication component.

Various of the elements in the actuarial system 100 can be referred to as a “server.” Such elements can include a server device. The server device can include a physical server and/or a virtual server. For example, the server device can include one or more bare-metal servers. The bare-metal servers can be single-tenant servers or multiple tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers. The term server can refer to functionality of a device and/or an application operating on a device. For example, an application server can be programming instantiated in an operating system installed on a memory device and run by a processing device. The application server can include instructions for receiving, retrieving, storing, outputting, and/or processing data. A processing server can be programming instantiated in an operating system that receives data, applies rules to data, makes inferences about the data, and so forth. Servers referred to separately herein, such as an application server, a processing server, a collaboration server, a scheduling server, and so forth can be instantiated in the same operating system and/or on the same server device. Separate servers can be instantiated in the same application or in different applications.

Various aspects of the systems described herein can be referred to as “data.” Data can be used to refer generically to modes of storing and/or conveying information. Accordingly, data can refer to textual entries in a table of a database. Data can refer to alphanumeric characters stored in a database. Data can refer to machine-readable code. Data can refer to images. Data can refer to audio. Data can refer to, more broadly, a sequence of one or more symbols. The symbols can be binary. Data can refer to a machine state that is computer-readable. Data can refer to human-readable text.

FIG. 3 illustrates a method 300 utilized to transform accounting inputs 302 into actuarial outputs 304. In embodiments, the method 300 can be performed by the actuarial system 100, e.g., the ACE 101 described above.

In particular, the transformation may be the transformation of accounting data into a contractual service margin (CSM) according to the International Financial Reporting Standard 17 (IFRS 17). The method 300 may further take as inputs master data 306, i.e., reference data that is used to perform calculations. As described in detail herein, the actuarial outputs may have an associated audit trail 308 enabling the transformation to be traced and reproduced exactly at any subsequent time.

The method 300 may include ingesting and validating 310 the accounting inputs. The result of the ingesting and validating 310 is then processed at calculating step 312, such as calculating CSM or other actuarial data. The results of the calculating step 312 may be the actuarial outputs 304 or the actuarial outputs 304 may be transformed relative to the results of the calculating step 312. For example, the results may be processed to generate 314 a report. The report may be subject to an approval step 316 in which the report is reviewed and approved by one or more human reviewers. Following the approval step 316, the report may be posted 318 as an official actuarial report. The report may also be subject to a reconciliation step 320.

The calculation step 312, report generation step 314, and approval step 316 are described in greater detail below with respect to FIG. 3. The ingesting and validating step 310 may include a data pipeline in which data payloads are imported, such as from staging storage. Ingested data may also be segregated (such as according to a type of data in the payload), validated, and possibly translated to a standardized format. The reconciliation step 320 may mirror some or all of steps 310-314 and may be performed according to any accounting approach for performing reconciliation as known in the art.

Some or all of the steps 310-320 may be accompanied by performing 322 version capture. Performing 322 version capture may include associating a version with each item of data, workflow, formula, calculation, procedure, software module, algorithm, and the like used in steps 310-320 such that the actuarial outputs 304 may be generated from the accounting inputs 302 and master data 306 at any time even when steps 310-320 or the master data 306 is subsequently modified.

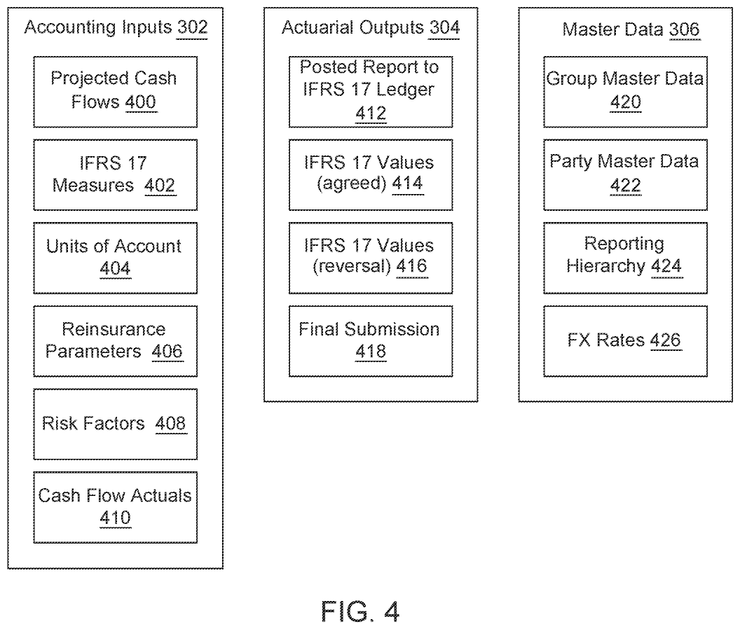

FIG. 4 illustrates details of the accounting inputs 302, actuarial outputs 304, and the master data 306. The accounting inputs 302, actuarial outputs 304, and the master data 306 may be stored in a database on one or more persistent storage devices and retrieved for use according to the method 300. The accounting inputs 302 may include projected cash flows 400, IFRS 17 measures 402, units of account 404, reinsurance parameters 406, risk factors 408, and cash flow actuals 410. Each of the accounting inputs 302 may be understood to include data according to the standard definitions of these terms in accounting practice. In particular, units of account 404 may include identifiers of business units of an entity for which accounting data is gathered separately, including some or all of the types of data 400, 402, 406, 408, and 410 referenced above. The accounting inputs 320 may be “time series data.” As used herein, “time series data” is data that has a date and/or time associated with it upon recordation such that this date and/or time is used to uniquely identify the data instead of a version number or version hierarchy.

The actuarial outputs 304 may include reports 412 posted to an IFRS 17 ledger, IFRS 17 values 414 that are found to agree with accounting data. Alternatively, IFRS 17 values that are not found to agree with accounting data may have corresponding IFRS 17 delta values 416, which may be a posting indicating a change relative to a previous posting of IFRS 17 values 414. The actuarial outputs 304 may further include a final submission 418, i.e., values posted to a general ledger of the entity performing the method 300 or that provided the accounting inputs 302 to the method 300. The final submission 418 may be a function of the report 412 and any delta values 416 posted with respect to the report 412. Other reports generated as part of the actuarial outputs may include profit and loss, summary of balances, and accumulated other comprehensive income (AOCI).

The master data 306 may be either time series data or may be versioned data such that each update to an item of data in the master data 306 is assigned a version number. “Master data” may be understood as low-volatility business data that is used to generate the report 412. The master data 306 may include group master data 420 and party master data 422. Group master data 420 may be master data 420 for a group of business units, such as departments of a single insurer or different insurers operating jointly. Party master data 422 may include master data for a single entity, e.g., single business unit.

The master data 306 may include a reporting hierarchy 424. The reporting hierarchy may include an organizational hierarchy for the entity performing the method 300 or for whom the method 300 is performed. The reporting hierarchy may define access permissions of individuals with respect to data in the accounting inputs 302 and the actuarial outputs 304. In particular, role-based access to procedures and/or results of the method 300 may be implemented using the reporting hierarchy 424. The master data 306 may include foreign exchange rates 426. The foreign exchange rates 426 may include exchange rates between currencies from different currency issuers.

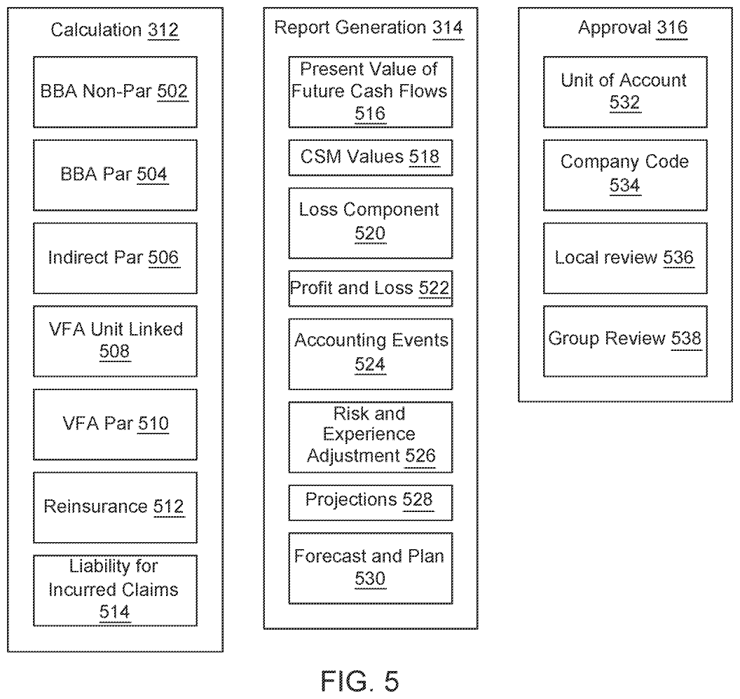

FIG. 5 illustrate sub-components of the calculation step 312, report generation step 314, and approval step 316. The sub-components may operate with respect to some or all of the accounting inputs 302. The calculation step 312 may include calculating 502 building block account (BBA) non-par values and calculating 504 BBA par values. The calculation step 312 may further include calculating 506 indirect par values. The calculation step 312 may include calculating 510 variable fee approach par values. The calculation step 312 may include calculating 512 reinsurance values (e.g., risk of non-performance) and calculating 514 liability for incurred claims. In some instances, coinsurance values are also calculated.

The report generation step 314 may include calculating 516 present value of future cash values, calculating 518 CSM values, calculating 520 loss components, calculating 522 profit and loss, identifying 524 accounting events, calculating 526 risk and experience adjustments, calculating 528 projections, and calculating 530 one or both of a forecast and a plan.

Reports generated according to the report generation step 314 may be subject to approval at the approval step 316. The approval step 316 may be performed with respect to each unit of account of a plurality of units of account, e.g., business units, subsidiaries, geographic subdivisions of an enterprise, or some other portion of a business. Likewise, some or all of steps 310-314 may be performed separately on the accounting inputs 302 for each unit of account 532 such that reports are generated at the report generation step 314 for each unit of account.

The approval step 316 may also be performed with respect to a company code 534 defining standards for evaluating and approving reports generated according to the report generation step 314. The approval step 316 may include receiving 536 approval from a local chief actuary for each portion of a report corresponding to a particular unit of account. The approval step 316 may include receiving 538 approval from a group chief actuary for an organization including the plurality of units of account.

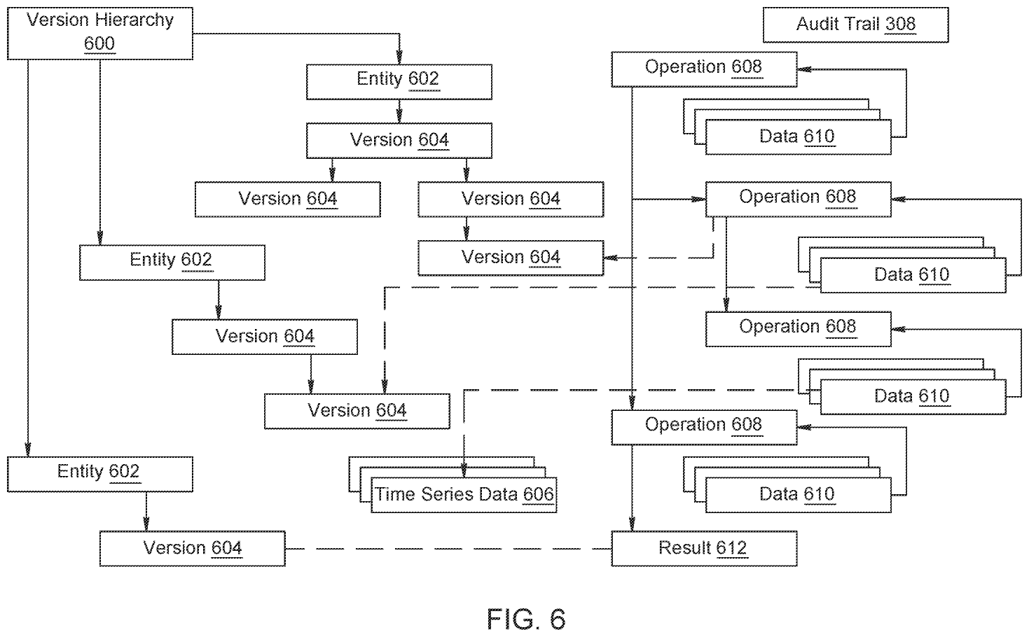

FIG. 6 illustrates an audit trail 308 such as may be generated by the version capture step 322 to record execution of the method 300 with respect to accounting inputs 302. The version capture step 322 may be performed in cooperation with maintaining a version hierarchy 600. The version hierarchy 600 may include a plurality of entity records 602. Each entity record 602 may represent a formula, workflow, procedure, software module, algorithm, or any other aspect of performing some or all of steps 310-322. Each entity record 602 may alternatively represent an item of data in the master data 306. Each entity record 602 may include one or more version records 604. Each version record 604 corresponds to a version of the entity referenced by the entity record and may include a date and/or time at which the version of the entity was available for use, a change log relative to previous versions of the entity, a reference to a file storing the version of the entity referenced by the version record 604, or other information. The version records 604 of each entity record 602 may be in the form of a hierarchy as shown. Accordingly, a child version record 604 of a parent version record 604 represents a version of an entity that is changed relative to the version of the entity represented by the parent version record 604. A parent version record 604 may have multiple child version records 602.

As noted above, time series data 606 is not versioned, but rather includes items or batches of data that are each labeled with a date and/or time that can be used to uniquely identify the item or batch of data.

The version hierarchy 600 and time series data 606 may be stored in a database on one or more persistent storage devices and retrieved to generate the audit trail 308 as discussed below.

The audit trail 308 may be in the form of a hierarchy or series of operations 608. Each operation 608 may correspond to execution of a formula, workflow, procedure, algorithm, software module, or any other aspect of performing some or all of steps 310-322. Each operation 608 may therefore correspond to an entity record 602 in the version hierarchy. The audit trail 308 may therefore associate each operation 608 with a version record 604 indicating which version of the operation was executed. For example, each version record 604 may have an identifier that is associated with a record of each operation 608 in the audit trail 308.

Operations 608 may operate with respect to one or more items of data 610, each item of data 610 may be included in the accounting inputs 302 or master data 306. Each item of data 610 may be represented by an entity record 602 in the version hierarchy 600 or may be part of time series data 606. In either case, the audit trail 308 may associate each item of data 610 with the version record 604 for that item of data that was used in executing the method 300 or with a time and/or date associated with the time series data 606 that was used.

One or more results 612 of execution of the method 300 may also be represented by entity records 602 such that each execution of the method 300 may be accompanied by creating a version record 604 representing the result 612. The one or more results 612 may include final results (e.g., reports posted to the general ledger) and may also include intermediate results of one or more of the operations 608.

Data representing the audit trail 308 as described above may be stored in a database on one or more persistent storage devices. The results 612 may also be stored in the database in association with the audit trail. Accordingly, audit trail 308 may be retrieved from the database at a later time and the method 300 may be repeated with respect to the data and operations indicated in the audit trail in order to replicate the results 612, thereby providing an auditable and verifiable calculation of the results 612. The database may be the same database or a different database than is used to store the version hierarchy 600.

The method 300 may be used as described above to generate reports. The method 300 may also be used in other contexts. For example, one or more inputs of the accounting inputs 302 may be artificially adjusted and processed according to the method 300 in order to evaluate the impact of the adjustment on the actuarial outputs 304. For example, the method 300 may be executed for the accounting inputs 302 having various values for the present value of future cash flows (PVFCF). The actuarial outputs 304 for each PVFCF value may then be obtained and evaluated. The adjustments to the accounting inputs 302 may be at the level of a single unit of account or a sub-unit of account of a particular unit of account. In this manner, risk associated with changes in PVFCF may be evaluated for an entity or a particular unit of account or sub-unit of account of the entity.

In yet another exemplary example, adjusted values of the accounting values 302 may be processed according to the method 300 to determine sensitivity of the actuarial outputs 304 to changes in the accounting values 302. Again, the adjustments may be at the level of a single unit of account or a sub-unit of account of a particular unit of account.

In another example, projections of future accounting values 302 may be processed according to the method 300 to estimate future values for the actuarial outputs 304, such as CSM.

FIG. 7 illustrates an exemplary computing device 700 that may be used to implement the actuarial system and methods described herein. The computing device 700 may include one or more processing devices 702 configured to execute instructions with respect to data. For example, the one or more processing devices 702 may be central processing units (CPU), graphics processing units (GPU), application specific integrated circuits (ASICS), field programmable gate array (FPGA) or other type of processing device.

The one or more processing devices 702 may be connected to a bus 704, such as a peripheral connect interface (PCI) bus or other type of bus. A non-volatile storage device 706 and volatile memory 708 may be connected to the one or more processing devices 702, such as by means of the bus 704. The non-volatile storage device 706 may include a hard disk drive (HDD), solid state drive (SSD), or other type of non-volatile storage device. The volatile memory 708 may include a random-access memory (RAM), such as dynamic RAM (DRAM) or other type of RAM.

Other devices may be connected to the bus 704, such as a network interface 710 for connecting the computing device 700 to a wired or wireless network. A display device 712 may be connected to the bus 704, such as a screen, touch screen, projector, or other display device. One or more input devices 714 may be connected to the bus 704, such as a mouse, keyboard, trackpad, or other type of input device 714.

One or both of the non-volatile storage device 706 and volatile memory 708 may store executable code that, when executed by the one or more processing devices 702, causes the one or more processing devices 702 to perform the methods disclosed herein. The methods disclosed herein may be performed by a computer system including one or more computing devices 700. Where the computer system includes a plurality of computing devices 700, the plurality of computing devices 700 may be connected by a network or chassis backplane.

For purposes of illustration, programs and other executable program components are shown herein as discrete blocks, although it is understood that such programs and components may reside at various times in different storage components 706, 708 of computing device 700, and are executed by the one or more processing devices 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Memory in the processing devices 702 can be allocated dynamically according to variables, variable states, static objects, and permissions associated with objects and variables in the actuarial system 100. Such memory allocation can be based on instructions stored in the memory devices, e.g., volatile memory 708 and/or non-volatile storage devices 706. Memory resources at a specific device can be conserved relative to other systems that do not associate variables and other objects with permission data for the specific device. The processing devices 702 can generate an output based on an input. For example, the processing device can receive an electronic and/or digital signal. The processing devices can read the signal and perform one or more tasks with the signal, such as performing various functions with data in response to input received by the processing device. The processing devices can read from memory devices, e.g., volatile memory 708 and/or non-volatile storage devices 706, information needed to perform the functions. For example, the processing devices 702 can update a variable from static to dynamic based on a received input and a rule stored as data on the memory device. The processing devices 702 can send an output signal to the memory devices, e.g., volatile memory 708 and/or non-volatile storage devices 706, and the memory device can store data according to the signal output by the processing device.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as disclosed above.

1. A method comprising:
receiving, by a computer system, a plurality of accounting inputs;
generating, by the computer system, a plurality of actuarial outputs from the plurality of accounting inputs according to a plurality of operations;
generating, by the computer system, an audit trail for the plurality of actuarial outputs by associating the plurality of operations with version data of the plurality of operations in a database; and
storing the audit trail in the database in association with the plurality of actuarial outputs.

2. The method of claim 1, wherein the plurality of accounting inputs include actual cash flows and projected cash flows.

3. The method of claim 1, wherein the plurality of actuarial outputs include a contractual service margin.

4. The method of claim 1, wherein the plurality of actuarial outputs include outputs according to International Financial Reporting Standard 17.

5. The method of claim 1, wherein the version data includes a version hierarchy.

6. The method of claim 1, further comprising adding one or more references to the plurality of actuarial outputs to the version data.

7. The method of claim 1, wherein generating the plurality of actuarial outputs further comprises using master data and including version data associated with the master data with the audit trail.

8. The method of claim 1, wherein at least a portion of the plurality of accounting inputs is time series data, the version data excluding any reference to the time series data.

9. The method of claim 1, further comprising:
ingesting and validating, by the computer system, the plurality of accounting inputs; and
associating, by the computer system, version data of the ingesting and the validating with the audit trail.

10. The method of claim 1, wherein the plurality of accounting inputs are first accounting inputs and the plurality of actuarial outputs are first actuarial outputs, the method further comprising:
adjusting, by the computer system, the first accounting inputs to obtain second accounting inputs;
generating, by the computer system, second actuarial outputs based on the second accounting inputs; and
evaluating, by the computer system, the second actuarial outputs with respect to the first actuarial outputs.

11. A system comprising:
one or more processing devices;
one or more memory devices coupled to the one or more processing devices, the one or more memory devices storing executable code that, when executed by the one or more processing devices, causes the one or more processing devices to perform a method comprising:
receiving a plurality of accounting inputs;
generating a plurality of actuarial outputs from the plurality of accounting inputs according to a plurality of operations;
generating an audit trail for the plurality of actuarial outputs by associating the plurality of operations with version data associated with the plurality of operations in a database; and
storing the audit trail in the database in association with the plurality of actuarial outputs.

12. The system of claim 11, wherein the plurality of accounting inputs include cash flow actuals and projected cash flows.

13. The system of claim 11, wherein the plurality of actuarial outputs include a contractual service margin.

14. The system of claim 11, wherein the plurality of actuarial outputs include outputs according to International Financial Reporting Standard 17.

15. The system of claim 11, wherein the version data includes a version hierarchy.

16. The system of claim 11, further comprising adding one or more references to the plurality of actuarial outputs to the version data.

17. The system of claim 11, wherein generating the plurality of actuarial outputs further comprises using master data and including version data associated with the master data with the audit trail.

18. The system of claim 11, wherein at least a portion of the plurality of accounting inputs is time series data, the version data excluding any reference to the time series data.

19. The system of claim 11, wherein the method further includes:
ingesting and validating, by the computer system, the plurality of accounting inputs; and
associating, by the computer system, version data of the ingesting and the validating with the audit trail.

20. The system of claim 11, wherein the plurality of accounting inputs are first accounting inputs and the plurality of actuarial outputs are first actuarial outputs; and
wherein the method further comprises:
adjusting the first accounting inputs to obtain second accounting inputs;
generating second actuarial outputs based on the second accounting inputs; and
evaluating, by the computer system, the second actuarial outputs with respect to the first actuarial outputs.
